(19) United States
(12) Patent Application Publication
(10) Pub. No.: US 2007/0082111 A1
(43) Pub. Date: Apr. 12, 2007

(54) Stabilisation of polyunsaturated fatty acid (pufa) ester concentrates

(76) Inventor: Neil Macfarlane, Elloughton North Humberside (GB)

Correspondence Address: Stephen M. Haracz;Bryan Cave, 1290 Avenue of the Americas, New York, NY, 10104, US

(21) Appl. No.: 10/576,931

(22) PCT Filed: Oct. 13, 2004
(86) PCT No.: PCT/EP04/11469

§ 371 Date: Apr. 20, 2006

(30) Foreign Application Priority Data
Oct. 21, 2003 (EP) 03024202.8

(51) Int. Cl. A23D 9/00

(52) U.S. Cl. 426/601; 426/321

(57) ABSTRACT

A method stabilising ethyl ester concentrates of polyunsaturated fatty acids by adding to the concentrate a mixture of rosemary or sage extract, ascorbyl palmitate and tocopherols before a standard deodorisation process and crystallization inhibitor before or after the deodorization process, the concentrates thus obtained and their use in food applications.

Today there is reasonable evidence that increasing dietary levels of unsaturated fatty acids can reduce the incidence of death from coronary heart diseases via effects on blood pressure, atherosclerosis, and thrombogenesis.

The unsaturated fatty acids comprise monounsaturated fatty acids (MUFAs), e.g., oleic and palmitoleic acid, and polyunsaturated fatty acids (PUFA). Examples of n-6 PUFAs are linoleic acid (C₁₈: 2) and arachidonic acid (C₂₀: 4); examples of n-3 PUFAs are α-linolenic acid (C₁₈: 3), eicosapentaenoic acid (EPA, C₂₀: 5), and docosahexaenoic acid (DHA, C₂₂: 6). Especially EPA and DHA have attracted interest of the food industry in recent years. The most available sources of these two fatty acids are fish and the marine oils extracted from them.

With increasing number of double bonds the PUFAs are subject to increasing oxidative degradation and development of undesirable “off-flavors”, mainly fishy smell and taste. The increasing interest in the PUFAs, especially long-chain PUFAs (LCPUFAs), such as EPA and DHA, has prompted research in methods of refining and stabilization of fish oils and concentrates of PUFAs.

It has been known for a long time that freshly refined marine oils are initially free from off-flavors and a taste and smell of fish but that reversion through oxidation occurs rapidly. Many attempts have been made to stabilize the oils by the addition of different anti-oxidants of mixtures thereof. However, all these attempts have failed so far or still left open the possibility of further improvements (see, e.g. Hamilton, R. J. et al., Journal of American Oil and Chemists' Society (JAOCS), 75, 813-822 [1998]).

Refined marine oil which has been treated with silica and been stabilised by addition of a mixture of lecithin, ascorbyl palmitate and alpha tocopherol and subsequent soft vacuum deodorisation at a temperature between about 140° C. and 210° C. in accordance with the procedure described in European patent publication No. 612 346 shows excellent Rancimat stability and good application performance mainly for health food supplements. In dairy applications such as yoghurts and milk drinks, however, this oil develops a strong fish smell and taste.

Refined marine oils which have been treated according to the procedure described in European patent publication No. 340 635, i.e. by vacuum steam distillation and treatment with an adsorbent such as silica gel or silicic acid, and which has been stabilised with 0.1% deodorised rosemary extract (HERBALOX “O”, Kalsec, Inc. of Kalamazoo, Mich.) or sage extract has a herby taste and smell which can be detected in food applications. This herby taste and smell supresses the taste and smell of fish. In dairy applications, however, the use of as little as 0.03% of HERBALOX “O” and, respectively, sage extract in the marine oil results in a very strong herby taste and smell which prevents the use of this oil in these applications.

According to European patent application publication No. 999 259 fully refined marine oils which have been neutralized, bleached and deodorized in a conventional manner are stabilized over a long period of time without the occurrence of fishy taste and smell by treatment with silica, optionally in the presence of carbon, vacuum steam deodorization at a temperature between about 140° C. and about 210° C. in the presence of 0.1-0.4% of rosemary or sage extract and, optionally, after deodorization, addition of 0.01-0.03% ascorbyl palmitate and 0.05-0.2% mixed tocopherols.

However, when applying that method in a pilot trial to a concentrate of PUFA ethyl esters the result was disappointing and demonstrated that this procedure is not good enough for stabilisation of PUFA ester concentrates. To 20 kg of a mixture containing 40-50% ethyl EPA and 20-30% ethyl DHA 0.2% of rosemary extract (HERBALOX “O”) was added before the deodorization at 140° C. followed by addition of 0.1% mixed tocopherols and 0.02% of ascorbyl palmitate after deodorisation. Immediately on completion of the deodorisation and cool down to room temperature the esters had a mild and not fishy taste. The esters were packaged into aluminium containers in a glove box under nitrogen for future stability testing. The first sampling took place two weeks after production and the esters were rejected as having a very strong fish taste and smell.

In accordance with the present invention, it has been found, however, that addition of a combination of rosemary or sage extract, mixed tocopherols and ascorbyl palmitate before the deodorisation process resulted in a mild tasting product free from fishy taste and free from chemical taste. If this product, however, is stored at low temperatures, especially at the preferred temperature of about −18° C., it has turned out that this product is no longer readily flowable and becomes turbid which renders it esthetically less attractive and more difficult to handle because of its loss of homogeneity. This disadvantage, however, can be avoided by addition to the concentrate of an effective amount of a crystallisazion inhibitor, e.g., a lecithin or lecithin-like compound, before or after the deodorisation process.

Therefore, the present invention relates to a method of stabilising ester concentrates of polyunsaturated fatty acids (PUFAs) by adding to the concentrate (a) a mixture of rosemary or sage extract, ascorbyl palmitate and tocopherols before submitting it to a standard deodorisation process and (b) a crystallization inhibitor before or after the deodorisation process to stabilized PUPA ester concentrates thus obtained as well as to the use of the thus stabilized PUFA ester concentrates in food applications.

All percentages in the specification and claims unless otherwise specified are on a w/w basis.

The ester concentrates to be stabilised by the process of the present invention are commercially available products or can be prepared according to methods well-known in the art, e.g. from marine oils. For example, the manufacturer Ocean Nutrition, Canada, offers such concentrates which are produced from marine oils by interesterification with ethanol and subsequent distillation. They contain about 40-50% of ethyl EPA and about 20-30% of ethyl DHA. However, the present process can be applied to any concentrates of PUFA esters, preferably ethyl esters of n-3 and n-6 PUFAs, especially those which are of nutritive interest and importance but subject to degradation and development of undesirable off-flavors which would render them unsuitable for food application. Of particular interest with this respect are esters, especially the ethyl esters, of EPA and DHA.

The term “concentrate” relates to a broad concentration range and indicates that the content of a single ester or of mixtures of PUFA esters is higher than in a naturally occurring product. Preferred concentrates are those which consist of either synthetically produced PUFA esters of high purity or already refined products obtained from nature and free from the majority of naturally accompanying substances. In specifically interesting embodiments of the present invention the concentration of PUFA esters in concentrates to be stabilized is higher than 50%, e.g., in the range of 60-80%, and preferably at least 70%.

The term “crystallization inhibitor” in the present context is meant to encompass all compounds which are known to and used to inhibit the crystallization of edible oils or their components at low temperatures, viz. temperatures below room temperature, especially when such oils are stored in refrigerators or deep-freezers, i.e. at temperatures at least as low as −18° C. The crystallization inhibitors when added to the concentrates will keep the oily concentrates in a readily flowable phase. Examples of preferred crystallization inhibitors useful in the context of the present invention are lecithins. The term “lecithin” is well-known in the art. However, it covers not only the compounds in the strictly scientific sense, viz. pure phosphatidyl cholines, but also products which are mixtures of different components which are defined according to the original source and the purification process by which they are obtained and which vary in their constituents both qualitatively and quantitatively (see, e.g., Kirk-Othmer, Encyclopedia of Chemical Technology, 4^{th} edition, vol. 15, p. 192-194). Therefore, while pure phosphatidyl cholines can be used as well as all highly pure natural or synthetic mixtures of components covered by the term “lecithin” it is conceivable that from an economical point of view those products are preferred which are properly refined, i.e.,

to an extent that they have practically no odor, a bland taste and a light or no colour. Therefore, any food-grade or cosmetic-grade lecithin can be used in the present invention. It is, however, preferred to use a solid and/or liquid food-grade lecithin which is commercially available. Examples of such preferred lecithins are Epikuron® 100G (Lucas Meyer, D-2000 Hamburg, Germany) and Topcithin® (Lucas Meyer, D-2000 Hamburg, Germany).

The effective amount of lecithin to be added before or after the deodorisation process can easily be determined by the person skilled in the art and is normally in the range of 0.01% to 1.0%, preferably from 0.02% to 0.05%.

Any deodorisation vessel which is commercially available or any vessel which is large enough and fitted with the necessary components to carry through the process of the present invention can be used.

The other components which are added to the PUFA ester concentrate before deodorisation according to the present process are also well-known to a person skilled in the art and commercially available. The amounts of the components to be added are
0.05-4.0%, preferably about 0.1% to 0.2%, for rosemary or sage extract;
0.01-0.04%, preferably about 0.025%, for ascorbyl palmitate and
0.05-0.5%, preferably about 0.2%, for a tocopherol (α- β-, γ- or δ-tocopherol or mixtures thereof), preferably γ-tocopherol.
   Further ingredients which are able to prevent or slow down the deterioration of PUFAs may be added to the concentrates before or after the deodorisation process. Such ingredients are known to the person skilled in the art and comprise, e.g., metal complexing agents, such as citric acid and ascorbic acid. They may be added in an amount sufficient to be present in the end product in the range of 0.001-0.01%, preferably of about 0.005%.

Any standard deodorisation process can be used which is known, e.g. for the deodorisation of marine oils, the preferred process being soft vacuum steam deodorisation. After deaeration of the mixture by applying a vacuum of about 5-10 mbar steam is injected and the process is conducted for 1 to 5 hours, preferably for 2 hours, at a temperature between about 120° C. and 150° C. depending on the vacuum and the volatility of the PUFA esters, normally between 0.1 and 10 mbar. A temperature of about 140° C. at about 1-5 mbar is usually preferred, especially for the deodorisation of EPA and DHA ethyl ester concentrates.

After deodorisation the product is cooled, preferably under protection of an inert gas such as nitrogen or argon, and if appropriate after filtration, packaged into suitable containers again preferably under inert gas protection.

Using the Rancimat (described, e.g., in European patent application publication No. 999 259) the stability of the product obtained in accordance with the present process can be determined and its advantageous properties compared with products obtained by prior art processes.

The PUPA ester concentrates stabilised according to the process of the present invention can be used for the preparation of food applications, including dietary supplements, and animal feed products. Examples of such food applications are given, e.g., in European patent application publication No. 999 259. By adding the stabilized PUFA ester concentrates of the present invention using methods known in the art to food, the food is enriched with these esters and thus improved.

### EXAMPLES

The ethyl ester concentrate used in the following Examples was purchased from Ocean Nutrition, Canada. The esters were stored under nitrogen with no added anti-oxidant before use. The fatty acid composition of the ethyl ester concentrate is recorded below.

| Fatty acid | % |
|---|---|
| C14:0 | 0.07 |
| C16:0 | 0.28 |
| C16:1 N-7 | 0.16 |
| C17:0 | 0.05 |
| C17:1 | 0.07 |
| C18:0 | 2.21 |
| C18:1 N-9 | 3.47 |
| C18:1 N-7 | 1.29 |
| C18:2 N-6 | 0.58 |
| C18:3 N-6 | 0.30 |
| C18:3 N-3 | 0.65 |
| C18:4 N-3 | 1.11 |
| C20:0 | 0.60 |
| C20:1 N-9 | 2.49 |
| C20:2 N-6 | 0.35 |
| C20:3 N-6 | 0.49 |
| C20:3 N-3 | 0.43 |
| C20:4 N-3 | 2.05 |
| C20:5 N-3 | 42.45 |
| C22:0 | 0.32 |
| C22:1 N-11 | 1.32 |
| C22:1 N-9 | 0.27 |
| C21:5 N-3 | 2.16 |
| C22:5 N-3 | 4.35 |
| C22:6 N-3 | 26.08 |
| C24:1 N-9 | 0.28 |
| unidentified | 6.12 |

The esters were subject to Rancimat oxidation and exhibited an induction time of 0.25 hours at 80° C. with 20 lts/hour air flow and 70 mls water in the conductivity chamber. A sample of esters was put into a 20 mls vial and cooled to −18° C. The sample appeared solid and could not be poured from the vial at −18° C.

The fish taste of the sample was 7 where the number relates as:

| FAST Index | DESCRIPTION |
|---|---|
| 1 | Not fishy |
| 2 | Very slightly fishy |
| 3 | Slightly fishy |
| 4 | Middle fishy |
| 5 | Strong fishy |
| 6 | Very strong fishy |
| 7 | Extremely fishy |

### Example 1

500 gms of the ester concentrate was taken and 2000 ppm mixed tocopherols, 1000 ppm herbalox, 250 ppm ascorbyl palmitate and 50 ppm citric acid were added. The esters and anti-oxidant mixture were put into a laboratory glass deodoriser and vacuum was applied between 1-5 mbar. The mixture was heated. At approximately 60° C., steam was introduced into the oil and the heating continued until a temperature of approximately 140° C. was reached. The mixture was deodorised under these conditions for 2 hours before cooling to 60° C. when the steam flow was stopped and replaced with a stream of nitrogen. At approximately 40° C. the nitrogen flow was stopped and the deodoriser vessel sealed and stored in the dark before further experiments were done. The esters were subject to Rancimat oxidation and exhibited an induction time of 12.4 hours at 80° C. with 20 lts/hour air flow and 70 mls water in the conductivity chamber. A sample of esters was put into a 20 mls vial and cooled to −18° C. The sample appeared solid and could not be poured from the vial at −18° C. The sample had no fish taste and a FAST index (see Inform 12, 244-249, March 2001) of 1 (not fishy).

### Example 2

An experiment was done according to Example 1 but with the addition of 250 ppm liquid lecithin (Topcithin®, Lucas Meyer) prior to the deodorisation. The deodorised sample had a Rancimat induction time of 11.1 hours. It remained liquid at −18° C. and was easily pourable from the container at −18° C. The sample had a FAST index of 1 (not fishy).

### Example 3

An experiment was done according to Example 1 but with the addition of 250 ppm liquid Topcithin® after the deodorisation. The sample had a Rancimat induction time of 11.15 hours. It remained liquid at −18° C. and was easily pourable from the container at −18° C. The sample had a FAST index of 1 but a distinctive beany taste which originated from the lecithin.

### Example 4

An experiment was done according to Example 1 but with the addition of 250 ppm solid lecithin (Epikuron®, Lucas Meyer) before deodorisation. The sample had a Rancimat induction time of 10.15 hours. It remained liquid at −18° C. The sample had a fish taste of 1 according to the FAST index.

1. A method of stabilizingester concentrates of polyunsaturated fatty acids (PUFAs) by (a) adding a mixture of rosemary or sage extract, ascorbyl palmitate and tocopherols to the concentrates before submitting the concentrates to a standard deodorization process and (b) adding a crystallization inhibitor to the concentrates before or after the deodorization process.

2. The method of claim 1 wherein further additives, able to prevent deterioration of PUFAs, are added to the concentrates before or after the deodorization process.

3. The method of claim 1 wherein the ester concentrates are ethyl esters.

4. The method of claim 1, wherein a concentrate of ethyl esters of eicosapentaenoic acid and docosahexaenoic acid is deodorized.

5. The method of claim 1, wherein the concentrates contain more than 50% of PUFA ethyl esters.

6. The method of claim 1, wherein 0.05-4.0% of rosemary or sage extract is added.

7. The method of claim 1 wherein 0.01-0.04%, of ascorbyl palmitate is added.

8. The method of claim 1, wherein 0.05-0.5% of tocopherols is added.

9. The method of claim 1, wherein the crystallization inhibitor is a lecithin.

10. The method of claim 9 wherein 0.01%-1.0% of a lecithin is added.

11. The method of claim 1, wherein 0.001-0.01% of citric acid is added.

12. The method of claim 1, wherein vacuum steam deodorization is used.

13. The method of claim 12, wherein the vacuum steam deodorization is effected at a temperature between about 120° C. and about 150° C. at 0.1-10 mbar.

14. Stabilized PUFA ester concentrates made by the method of claim 1.

15. (canceled)

16. A method of enriching food with PUFA esters comprising adding stabilized PUFA ester concentrates according to claim 14 to the food.

17. The method of claim 6, wherein 0.1-0.2% of rosemary or sage extract is added.

18. The method of claim 7, wherein 0.025% of ascorbyl palmitate is added.

19. The method of claim 8, wherein 0.2% of tocopherols is added.

20. The method of claim 9 wherein 0.02%-0.05% of a lecithin is added.

21. The method of claim 11, wherein 0.005% of citric acid is added.
